(19) United States
(12) Patent Application Publication
(10) Pub. No.: US 2011/0038325 A1
(43) Pub. Date: Feb. 17, 2011

(54) SYSTEM AND METHOD FOR SCHEDULING PACKETS IN A COMMUNICATION SYSTEM

(75) Inventor: Subir Varma, San Jose, CA (US)

Correspondence Address: O'Brien Jones PLLC (w/Clearwire), 1951 Kidwell Drive, Suite 550 B, Tysons Corner, VA, 22182, US

(73) Assignee: Clear Wireless LLC, Kirkland, WA (US)

(21) Appl. No.: 12/540,916

(22) Filed: Aug. 13, 2009

(51) Int. Cl. H04W 72/12

(52) U.S. Cl. 370/329

(57) ABSTRACT

A method and system of operating a communication system to schedule packets is provided. In part, if a first application has a first minimum rate guarantee, a first weight is assigned to a first packet based on the first minimum rate guarantee. If the second application has a second minimum rate guarantee, then a second weight is assigned to a second packet based on the second minimum rate guarantee. A first channel performance indicator is determined based on how a first channel is performing compared to a first channel condition history and a second channel performance indicator is determined based on how a second channel is performing compared to a second channel condition history. Furthermore, the method comprises scheduling the first and second packets based on the first and second weights and on the first and second channel performance indicators.

### TECHNICAL BACKGROUND

Wireless communication may be used as a means of accessing a network and has certain advantages over wired communications for accessing a network. One of those advantages is a lower cost of infrastructure to provide access to many separate locations or addresses compared to wired communications. This is the so-called “last mile” problem. Another advantage is mobility. Wireless communication devices, such as cell phones and wireless modems, are not tied by wires to a fixed location. To use wireless communication to access a network, a customer needs to have at least one transceiver in active communication with another transceiver that is connected to the network.

To facilitate wireless communications, the Institute of Electrical and Electronics Engineers (IEEE) has promulgated a number of wireless standards. These include the 802.11 (WiFi) standards and the 802.16 (WiMAX) standards. Likewise, the International Telecommunication Union (ITU) has promulgated standards to facilitate wireless communications. This includes TIA-856, which is also known as Evolution-Data Optimized (EV-DO). This and certain other ITU standards may be known as the CDMA2000 group of standards. The European Telecommunications Standards Institute (ETSI) has also promulgated a standard known as long term evolution (LTE). Additional standards such as the fourth generation communication system (4G) are also being pursued. These standards pursue the aim of providing a comprehensive communication solution where voice, data, and streamed multimedia can be given to users on an “anytime, anywhere” basis. These standards also aim to provide higher data rates than previous generations. All of these standards may include specifications for various aspects of wireless communication with a network. These aspects include processes for registering on the network, carrier modulation, frequency bands of operation, and message formats.

### Overview

A method and system for operating a communication system to schedule packets is generally described herein. A first packet of a first plurality of packets is received that is to be sent to a first application running on a first wireless device. The first packet is received over a first channel and the first channel has a first channel condition history. A second packet of a second plurality of packets is received to be sent to a second application running on a second wireless device. The second packet is received over a second channel and the second channel has a second channel condition history.

If the first application has a first minimum rate guarantee, a first weight is assigned to the first packet based on the first minimum rate guarantee. If the second application has a second minimum rate guarantee, then a second weight is assigned to the second packet based on the second minimum rate guarantee. A first channel performance indicator is determined based on how the first channel is performing compared to a first channel condition history and the second channel performance indicator is determined based on how the second channel is performing compared to a second channel condition history. Furthermore, the method comprises scheduling the first and second packets based on the first and second weights and on the first and second channel performance indicators.

### BRIEF DESCRIPTION OF THE DRAWINGS

FIG. 1 is a block diagram illustrating a communication system.

FIG. 2 is a flow diagram illustrating a method of scheduling packets in a communication system.

FIG. 3 is a block diagram illustrating a communication system.

FIG. 4A is a flow diagram illustrating a method of operating a packet based communication system.

FIG. 4B is a flow diagram illustrating a method of operating a packet based communication system.

FIG. 5 is a block diagram illustrating a communication control system.

### DETAILED DESCRIPTION

Multiple data flows, packet flows, traffic flows or service flows may be available over a wireless communication system. When multiple packet flows are present within a single communication system a scheduling algorithm is generally employed.

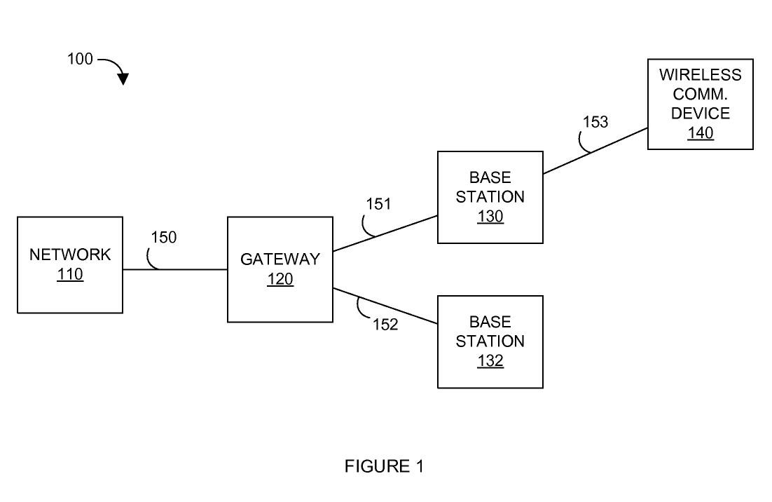

FIG. 1 is a block diagram illustrating communication system 100. Communication system 100 is configured to exchange packet based communication signals between network 110 and wireless communication device 140. Communication system 100 includes network 110, gateway 120, base station 130, base station 132, and wireless communication device 140.

Communication system 100 also comprises communication links 150, 151, and 152 that may include wired links, wireless links, or any combination or variation thereof. Communication link 150 carries communication signals between network 110 and gateway 120. Communication link 151 carries communication signals between gateway 120 and base station 130. Communication link 152 carries communication signals between gateway 120 and base station 132. Communication link 153 comprises a wireless communication link. Communication link 153 carries communication signals between base station 130 and wireless communication device 140. Communication link 153 may have more than one communication channel to allow for multiple packet flows to be sent simultaneously to wireless communication device 140.

Network 110 may comprise a computer, a network, or a collection of computers and networks that couple, link, or otherwise operatively provide wireless communication device 140 with communication service. It should be understood that network 110 may comprise secondary data networks. For example, network 110 may include a backhaul network, a local network, a long distance network, a packet network, or any combination thereof, as well as other types of networks. Network 110 may be or include an access service network (ASN), wireless local access network access gateway (WAG), packet data gateway (PDG), mobile switching center (MSC) and packet data serving node (PDSN).

Base stations 130 and 132 may be any wireless system that provides the air interface to wireless communication device 140, and communication connectivity to network 110 via gateway 120. Examples of base stations that may be utilized include, base transceiver stations (BTSs), radio base stations (RBSs), Node B, enhanced Node B (eNBs) and others. Base stations may include a number of elements known to those skilled in the art comprising a transceiver, power amplifier, combiner, duplexer, antenna and control function.

Wireless communication device 140 comprises Radio Frequency (RF) communication circuitry and an antenna. The RF communication circuitry typically includes an amplifier, filter, modulator, and signal processing circuitry. Wireless communication device 140 may also include a user interface, memory device, software, processing circuitry, or some other communication components. Wireless communication device 140 may be a telephone, computer, e-book, mobile Internet appliance, wireless network interface card, media player, game console, or some other wireless communication apparatus—including combinations thereof. Wireless communication device 140 may establish communication sessions with gateway 120 in order to receive user data from network 110. The user data may include video, audio, image, or data, as well as other types of user data.

Wireless communication device 140 may establish communication sessions with base station 130 in order to receive communication services via wireless link 153. These services may include voice services and data services. These communication services may include but are not limited to telephone services, long distance services, mobile voice services, mobile data services, push-to-talk services, internet services, web browsing, email, pictures, picture messaging, video, video messaging, audio, voicemail, music, MP3's, ring tones, stock tickers, news alerts, and so on.

In an embodiment, some wireless devices and may be associated with high-priority applications or traffic flows. For example, these wireless devices may be sending and receiving large uploads and downloads, streaming live traffic, and other minimum bandwidth dependent applications, service flows, or traffic flows. Other wireless devices, such as wireless communication device 140, may be using applications that are intermittent and comprise small bursts of data or low priority traffic flows. For example, wireless communication device 140 may be exchanging small FTP sessions, HTTP exchanges, email, or browsing the web. The nature and quality of service to be associated with the applications, service flow, or traffic flows, associated with wireless communication device 140 may be communicated by network 110, gateway 120, base stations 130 or 132 or some combination thereof.

Traffic flows, packet flows, applications, or service flows may have one or more service flow classifications. For example, network 110 may direct a traffic flow to wireless device 140 that includes a service traffic flow classification for voice service and a service traffic flow classification for a web browsing service. Likewise, network 110 may direct a traffic flow to wireless device 140 that includes a service traffic flow classification for voice service and a service traffic flow classification for a web browsing service. The service traffic flow classifications for voice service and for web browsing service may have different quality of service (QoS) requirements. In an embodiment, the service flow classifications may include wireless traffic classifications. For example, for WiMAX wireless communication there are wireless traffic quality of service classifications that include: unsolicited grant service (UGS), real time polling service (rtPS), extended real time polling service (ertPS), non-real time polling service (nRTPS), and best effort (BE).

In an embodiment, some or all of these different service flow classifications may be associated with a guaranteed bandwidth. In other words, communication system 100 may be committed to providing a certain amount of bandwidth (i.e., bits per second) to each traffic flow with a particular service flow classification. To accomplish this, a predefined number of slots may be allocated to a particular service flow when the traffic flow is established. This predefined number of slots may be based on the bandwidth required by the service flow classification and the modulation and coding scheme being used to communicate the traffic flow.

The amount of data that can be exchanged via wireless link 153 depends upon air interface factors or channel conditions such as the number of wireless devices communicating via base station 130, interference, clutter, morphology, wireless device location, signal to interference and noise ratio (SINR) and wireless device mobility. To account for these air interface variations that impact channel conditions, a wireless standard may utilize multiple modulation and coding schemes. This allows wireless devices with poor air interface channel conditions to utilize a low bit rate modulation with a high redundancy coding scheme. Wireless devices with good air interface channel conditions may utilize higher bit rate modulation with a low or no redundancy coding scheme. Thus, wireless devices with good air interface conditions can exchange more data with base station 130 in a given time (or symbol) and frequency block than a wireless device with poor air interface conditions. A time and frequency block may be referred to as a slot.

For example, WiMAX specifies modulation and coding scheme combinations that include: QPSK and ½ CTC 6x; QPSK and ½ CTC 4x; QPSK and ½ CTC 2x; QPSK and ½ CTC 1x; 16 QAM and ½ CTC; 16 QAM and ¾ CTC; 64 QAM and ½ CTC; 64 QAM and ⅔ CTC; 64 QAM and ¾ CTC; and, 64 QAM and ⅚ CTC. With a 10 MHz system channel bandwidth, these modulation and coding schemes may provide communication capacity that may range from approximately 18 to approximately 560 bits per slot. Thus, the amount of information conveyed to base station 130 over wireless link 153 depends upon the modulation and coding schemes that wireless device 140 is using. In turn, the modulation and coding scheme that wireless device 140 is using is dependent upon the RF or channel conditions that wireless device 140 is operating in.

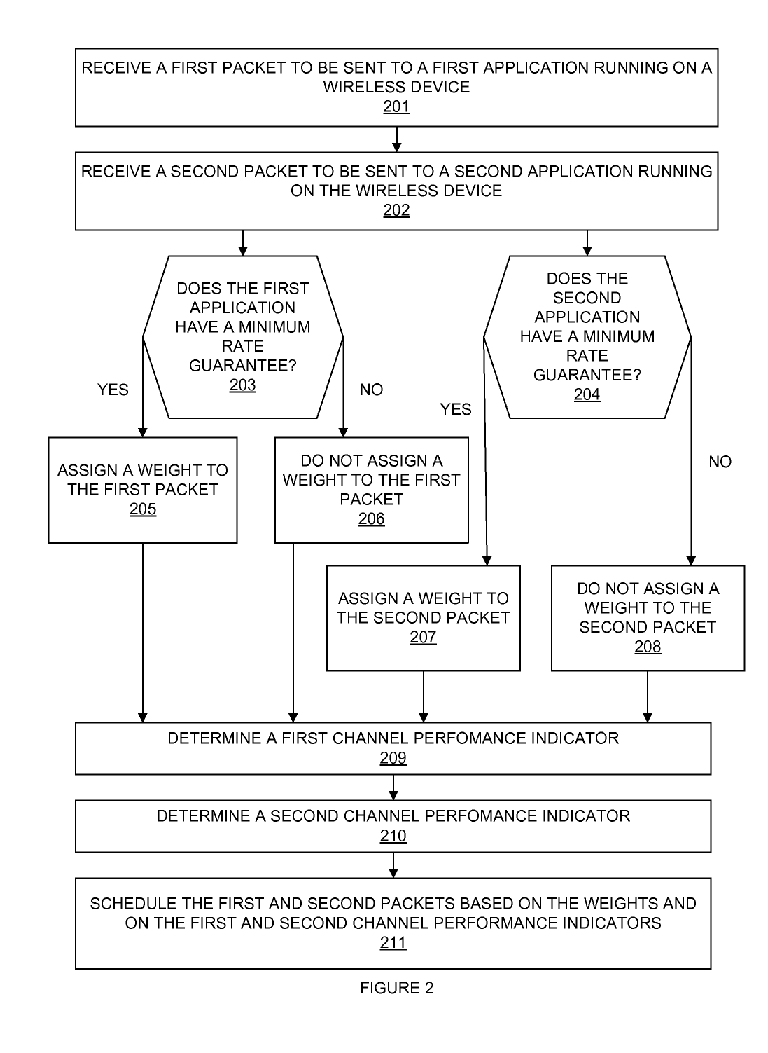

FIG. 2 is a flow diagram illustrating a method of scheduling packets in a communication system, such as communication system 100. In the packet based communication system illustrated in FIG. 1, network 110 and wireless communication device 140 exchange user data in a packet format via gateway 120 and base station 130. The user data exchanged between gateway 120 and wireless communication device 140 may be in the form of one of the multitude of data formats currently available for transmission over packet based wireless communication networks, such as voice, Internet, or video. Additionally, communication link 153 contains at least a first and second communication channel where the first channel has a first channel condition history and the second channel has a second channel condition history. A channel condition history is a measure of the quality of a given channel over time such that the better the channel condition history the more packets per unit of time can be transferred over that channel.

In step 201 gateway 120 receives a first packet, which is addressed to wireless communication device 140. Furthermore, the first packet is one of many packets destined for communication device 140 and is part of a first application running on wireless communication device 140. In step 202 gateway 120 receives a second packet, which is also addressed to wireless communication device 140. Like the first packet the second packet is one of many packets destined for communication device 140. However, unlike the first packet the second packet is part of a second application running on wireless communication device 140.

In step 203 gateway 120 determines if the first application has a minimum rate guarantee. A minimum rate guarantee as discussed above is a guarantee, which is usually given by a service provider as part of a service agreement with a customer, of a minimum packet transfer rate. If the first application has a first minimum rate guarantee, then in step 205 gateway 120 assigns a weight to the first packet based on the minimum rate guarantee. However, if the first application does not have a minimum rate guarantee, then in step 206 gateway 120 does not assign a weight to the first packet.

In step 204 gateway 120 determines if the second application has a minimum rate guarantee. If the second application has a minimum rate guarantee, then in step 207 gateway 120 assigns a weight to the second packet based on the minimum rate guarantee. However, if the second application does not have a minimum rate guarantee, then in step 208 gateway 120 does not assign a weight to the second packet.

The process for assigning priority or weights to the packets may occur by stamping the packets as they arrive at the scheduler with start tags and finish tags. This ensures that the traffic flow achieves minimum bit-rate guarantees in proportion to the weights that are assigned to the traffic flow.

In step 209 gateway 120 determines a channel performance indicator for the first channel based on how the first channel is performing compared to the first channel condition history. For example, if a channel is presently experiencing a channel condition that is better than that channel's condition history then the channel performance indicator would indicate as such. In step 210 gateway 120 determines a channel performance indicator for the second channel based on how the second channel is performing compared to the second channel condition history.

In an embodiment, the modulation and coding scheme is taken into account when determining the channel conditions for a packet. Cumulative distribution functions that are based upon the modulation and coding scheme of the particular traffic flow may be employed to determine the traffic flow priority.

In step 211 gateway 120 schedules the first and second packets to be delivered to the first and second applications running on wireless communication device 140 based on the weights and on the channel performance indicators of the first and second channels.

The scheduling of packets at step 211 ensures that the packets are serviced in increasing order of the start tags assigned to the packet. Further, the scheduler takes into account the channel conditions for the packet. This ensures that those flows and packets that have the best channel conditions relative to their own history are scheduled while maintaining the minimum bit-rate guarantees for the flows. Further, as known to one skilled in the art, this method advantageously works in those situations where traffic flows are subject to busy and idle periods or bursty traffic conditions. By taking into account the minimum bit-rate guarantees for a traffic flow, packets will still be scheduled even when channel conditions may degrade below certain thresholds.

The method of FIG. 2 may be implemented using a variety of scheduling algorithms. In an embodiment, to account for minimum bit rate guarantees, a rate guarantee scheduling algorithm may be employed. Examples of rate guarantee algorithms include but are not limited to weighted round-robin algorithms and Start Time Fair Queuing (STFQ) algorithms. To account for the channel conditions or multi-user diversity gain in a multi-user environment wireless system, other scheduling algorithms may be utilized. Examples of scheduling algorithms that take into account include round-robin schedulers, best channel interference to noise ratio schedulers, proportional fair schedulers, cumulative distribution function based schedulers and the like.

To take into account both minimum bit-rate guarantees and the channel conditions for the applications and devices, the following example may be employed utilizing the method illustrated in FIG. 2. For a particular traffic flow, the scheduler stamps the packet with a start tag when the packet arrives at the scheduler where the start tag is defined as a function of a finish tag of a previous packet. The packet finish tag is defined as a function of its start tag and the size of the packet flow and the weight of the service flow. The scheduler also uses a cumulative distribution function as known to those skilled in the art to allow the scheduler to take into account the channel conditions for the traffic flows. This is accomplished by assigning a value to a particular modulation and coding scheme, such as QPSK ½ is assigned a value of 1. These values are then used to index a packet for a particular slot and to ensure that the proper priority is established for the packet.

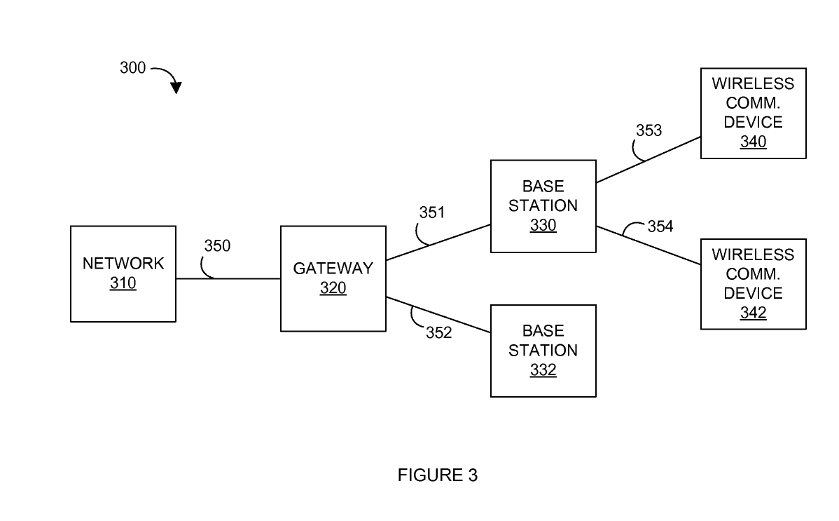

FIG. 3 is a block diagram illustrating communication system 300. Communication system 300 is configured to exchange packet based communication signals between network 310 and wireless communication devices 340 and 342. Communication system 300 includes network 310, gateway 320, base station 330, base station 332, wireless communication device 340 and wireless device 342.

Communication system 300 also comprises communication links 350, 351, 352, 353 and 354. Communication links 350, 351, and 352 may include wired links, wireless links, or any combination or variation thereof. Communication link 350 carries communication signals between network 310 and gateway 320. Communication link 351 carries communication signals between gateway 320 and base station 330. Communication link 352 carries communication signals between gateway 320 and base station 332. Communication links 353 and 354 comprises a wireless communication link. Communication link 353 carries communication signals between base station 330 and wireless communication device 340 and communication link 354 carries communication signals between base station 330 and wireless communication device 350. Communication links 353 and 354 may have more than one communication channel to allow for multiple packet flows to be sent simultaneously to wireless communication devices 340 and 342 respectively.

Network 310 may comprise a computer, a network, or a collection of computers and networks that couple, link, or otherwise operatively provide wireless communication devices 340 and 342 with communication service. It should be understood that network 310 may comprise secondary data networks. For example, network 310 may include a backhaul network, a local network, a long distance network, a packet network, or any combination thereof, as well as other types of networks. Network 110 may be or include an access service network (ASN), wireless local access network access gateway (WAG), packet data gateway (PDG), mobile switching center (MSC) and packet data serving node (PDSN).

Base stations 330 and 332 may be any wireless system that provides the air interface to wireless communication devices, and communication connectivity to network 310 via gateway 320. Examples of base stations that may be utilized include, base transceiver stations (BTSs), radio base stations (RBSs), Node B, enhanced Node B (eNBs) and others. Base stations may include a number of elements known to those skilled in the art comprising a transceiver, power amplifier, combiner, duplexer, antenna and control function.

Wireless communication devices 340 and 342 comprise Radio Frequency (RF) communication circuitry and an antenna. The RF communication circuitry typically includes an amplifier, filter, modulator, and signal processing circuitry. Wireless communication devices 340 and 342 may also include a user interface, memory device, software, processing circuitry, or some other communication components. Wireless communication devices 340 and 342 may be a telephone, computer, e-book, mobile Internet appliance, wireless network interface card, media player, game console, or some other wireless communication apparatus—including combinations thereof. Wireless communication devices 340 and 342 may establish communication sessions with gateway 320 in order to receive user data from network 310. The user data may include video, audio, image, or data, as well as other types of user data.

Wireless communication devices 340 and 342 may establish communication sessions with base station 330 in order to receive communication services via wireless links 353 and 354 respectively. These services may include voice services and data services. These communication services may include but are not limited to telephone services, long distance services, mobile voice services, mobile data services, push-to-talk services, internet services, web browsing, email, pictures, picture messaging, video, video messaging, audio, voicemail, music, MP3's, ring tones, stock tickers, news alerts, and so on.

In an embodiment, some wireless devices and applications may be associated with high-priority applications or traffic flows. For example, these wireless devices may be sending and receiving large uploads and downloads, streaming live traffic, and other minimum bandwidth dependent applications, service flows, or traffic flows. Other wireless devices, such as wireless communication devices 340 and 342, may be using applications that are intermittent and comprise small bursts of data or low priority traffic flows. For example, wireless communication device 340 may be exchanging small FTP sessions, HTTP exchanges, email, or browsing the web. The nature and quality of service to be associated with the applications, service flow, or traffic flows, associated with wireless communication device 340 may be communicated by network 310, gateway 320, base stations 330 or 332 or some combination thereof.

Traffic flows, packet flows, applications, or service flows may have one or more service flow classifications. For example, network 310 may direct a traffic flow to wireless devices 340 and 342 that include a service traffic flow classification for voice service and a service traffic flow classification for a web browsing service. Likewise, network 310 may direct a traffic flow to wireless devices 340 and 342 that include a service traffic flow classification for voice service and a service traffic flow classification for a web browsing service. The service traffic flow classifications for voice service and for web browsing service may have different quality of service (QoS) requirements. In an embodiment, the service flow classifications may include wireless traffic classifications. For example, for WiMAX wireless communication there are wireless traffic quality of service classifications that include: unsolicited grant service (UGS), real time polling service (rtPS), extended real time polling service (ertPS), non-real time polling service (nRTPS), and best effort (BE).

In an embodiment, some or all of these different service flow classifications may be associated with a guaranteed bandwidth. In other words, communication system 300 may be committed to providing a certain amount of bandwidth (i.e., bits per second) to each traffic flow with a particular service flow classification. To accomplish this, a predefined number of slots may be allocated to a particular service flow when the traffic flow is established. This predefined number of slots may be based on the bandwidth required by the service flow classification and the modulation and coding scheme being used to communicate the traffic flow.

The amount of data that can be exchanged via wireless links 353 and 354 depends upon air interface factors or channel conditions such as the number of wireless devices communicating via base station 330, interference, clutter, morphology, wireless device location, signal to interference and noise ratio (SINR) and wireless device mobility. To account for these air interface variations that impact channel conditions, a wireless standard may utilize multiple modulation and coding schemes. This allows wireless devices with poor air interface channel conditions to utilize a low bit rate modulation with a high redundancy coding scheme. Wireless devices with good air interface channel conditions may utilize higher bit rate modulation with a low or no redundancy coding scheme. Thus, wireless devices with good air interface conditions can exchange more data with base station 330 in a given time (or symbol) and frequency block than a wireless device with poor air interface conditions. A time and frequency block may be referred to as a slot.

For example, WiMAX specifies modulation and coding scheme combinations that include: QPSK and ½ CTC 6x; QPSK and ½ CTC 4x; QPSK and ½ CTC 2x; QPSK and ½ CTC 1x; 16 QAM and ½ CTC; 16 QAM and ¾ CTC; 64 QAM and ½ CTC; 64 QAM and ⅔ CTC; 64 QAM and ¾ CTC; and, 64 QAM and ⅚ CTC. With a 10 MHz system channel bandwidth, these modulation and coding schemes may provide communication capacity that may range from approximately 18 to approximately 560 bits per slot. Thus, the amount of information conveyed to base station 330 over wireless links 353 and 354 depends upon the modulation and coding schemes that wireless devices 340 and 342 are using. In turn, the modulation and coding scheme that wireless devices 340 and 342 are using is dependent upon the RF or channel conditions that wireless devices 340 and 342 operating in.

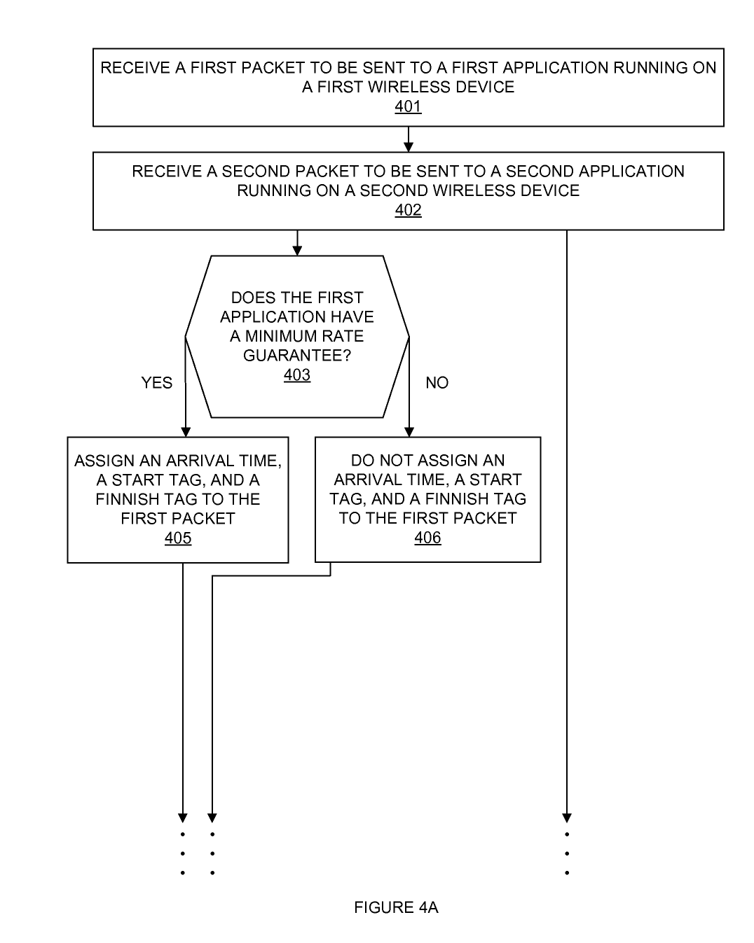

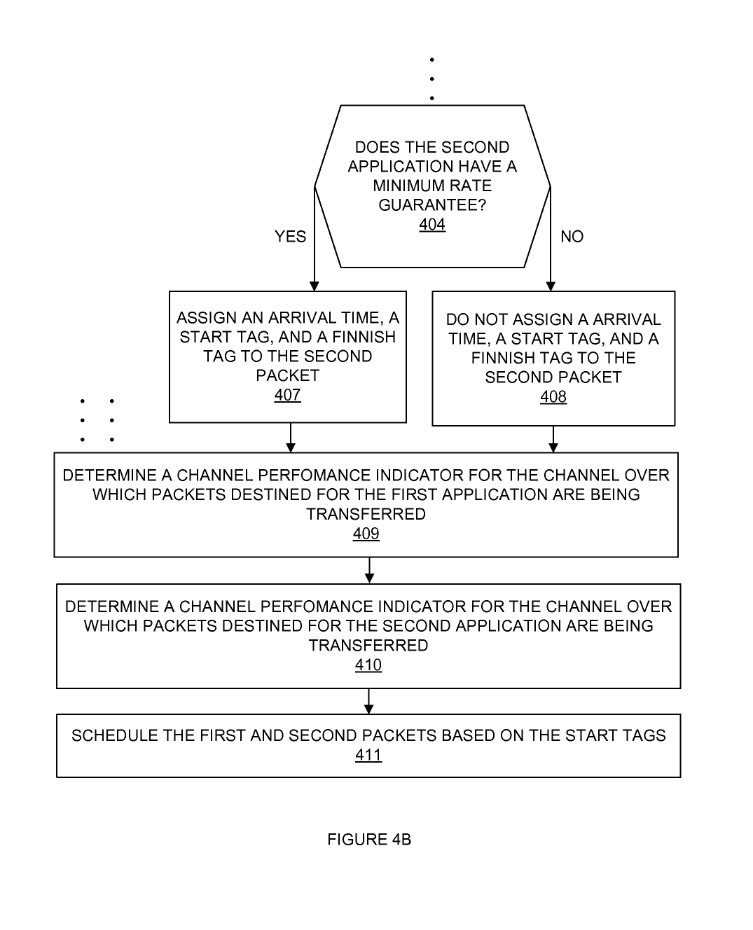

FIGS. 4A and 4B are a flow diagram illustrating a method of scheduling packets in a communication system, such as communication system 300. In the packet based communication system illustrated in FIG. 3, network 310 and wireless users using wireless communication devices 340 and 342 exchange user data in packet format. The user data exchanged between network 310 and wireless communication devices 340 and 342 may be in the form of one of the multitude of data formats currently available for transmission over packet based wireless communication networks, such as voice, Internet, or video. Additionally, communication links 353 and 354 each contain at least a first and second communication channel where each channel has a channel condition history. A channel condition history is a measure of the quality of a given channel over time such that the better the channel condition history the more packets per unit of time can be transferred over that channel.

In step 401 gateway 320 receives a packet, which is addressed to wireless communication device 340. Furthermore, the packet is one of many packets destined for wireless communication device 340 and is part of a first application running on wireless communication device 340. In step 402 gateway 320 receives a packet, which is addressed to wireless communication device 342. The packet is one of many packets destined for communication device 342. Moreover, the packet is part of a second application running on wireless communication device 342.

In step 403 gateway 320 determines if the first application has a minimum rate guarantee. If the first application has a first minimum rate guarantee, then in step 405 gateway 320 assigns an arrival time, a start tag, and a finish tag to the first packet based on the minimum rate guarantee. However, if the first application does not have a minimum rate guarantee, then in step 406 gateway 320 does not assign an arrival time, a start tag, and a finish tag to the first packet.

In step 404 gateway 320 determines if the second application has a minimum rate guarantee. If the second application has a minimum rate guarantee, then in step 407 gateway 320 assigns an arrival time, a start tag, and a finish tag to the second packet based on the minimum rate guarantee. However, if the second application does not have a minimum rate guarantee, then in step 408 gateway 320 does not assign an arrival time, a start tag, and a finish tag to the second packet.

The process for assigning priority or weights to the packets may occur by stamping the packets as they arrive at the scheduler with start tags and finish tags. This ensures that the traffic flow achieves minimum bit-rate guarantees in proportion to the weights that are assigned to the traffic flow.

In step 409 gateway 320 determines a channel performance indicator for the channel within communication link 353 over which packets destined for the first application running on wireless communication device 340 based on how the channel is performing compared to the channel condition history. In step 410 gateway 320 determines a channel performance indicator for the channel within communication link 354 over which packets destined for the second application running on wireless communication device 342 based on how the channel is performing compared to the channel condition history.

In an embodiment, the modulation and coding scheme is taken into account when determining the channel conditions for a packet. Cumulative distribution functions that are based upon the modulation and coding scheme of the particular traffic flow may be employed to determine the traffic flow priority.

In step 411 gateway 320 schedules the first and second packets to be delivered to the first and second applications running on wireless communication devices 340 and 342, respectively, based on the first and second start tags. Alternatively, gateway 320 may schedule the first and second packets to be delivered to the first and second applications based on the channel performance indicators or gateway 320 may schedule the first and second packets to be delivered to the first and second applications based on both the first and second start tags and on the channel performance indicators.

The scheduling of packets at step 411 ensures that the packets are serviced in increasing order of the start tags assigned to the packet. Further, the scheduler takes into account the channel conditions for the packet. This ensures that those flows and packets that have the best channel conditions relative to their own history are scheduled while maintaining the minimum bit-rate guarantees for the flows. Further, as known to one skilled in the art, this method advantageously works in those situations where traffic flows are subject to busy and idle periods or bursty traffic conditions. By taking into account the minimum bit-rate guarantees for a traffic flow, packets will still be scheduled even when channel conditions may degrade below certain thresholds.

The methods of FIGS. 4A and 4B may be implemented using a variety of scheduling algorithms. In an embodiment, to account for minimum bit rate guarantees, a rate guarantee scheduling algorithm may be employed. Examples of rate guarantee algorithms include but are not limited to weighted round-robin algorithms and Start Time Fair Queuing (STFQ) algorithms. To account for the channel conditions or multi-user diversity gain in a multi-user environment wireless system, other scheduling algorithms may be utilized. Examples of scheduling algorithms that take into account include round-robin schedulers, best channel interference to noise ratio schedulers, proportional fair schedulers, cumulative distribution function based schedulers and the like.

To take into account both minimum bit-rate guarantees and the channel conditions for the applications and devices, the following example may be employed utilizing the method illustrated in FIGS. 4A and 4B. For a particular traffic flow, the scheduler stamps the packet with a start tag when the packet arrives at the scheduler where the start tag is defined as a function of a finish tag of a previous packet. The packet finish tag is defined as a function of its start tag and the size of the packet flow and the weight of the service flow. The scheduler also uses a cumulative distribution function as known to those skilled in the art to allow the scheduler to take into account the channel conditions for the traffic flows. This is accomplished by assigning a value to a particular modulation and coding scheme, such as QPSK ½ is assigned a value of 1. These values are then used to index a packet for a particular slot and to ensure that the proper priority is established for the packet.

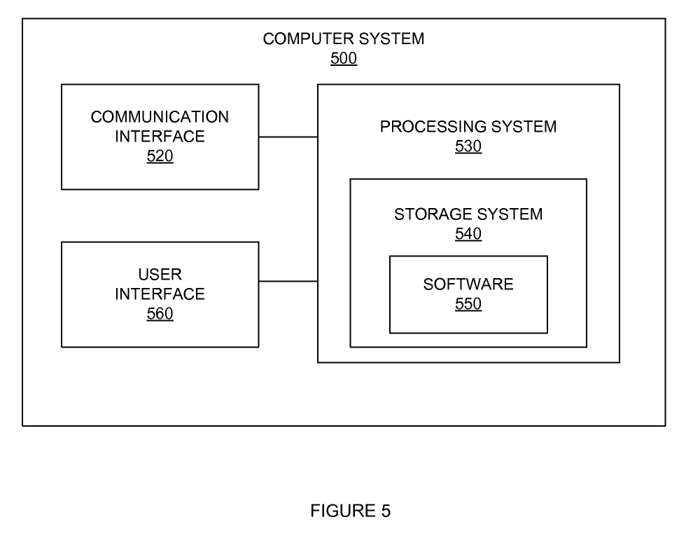

FIG. 5 is a block diagram illustrating a communication control system 500. Communication control system 500 comprises communication interface 520, processing system 530, and user interface 560. Processing system 530 comprises storage system 540. Storage system 540 stores software 550. Processing system 530 is linked to communication interface 520 and user interface 560. Communication control system 500 could be comprised of a programmed general-purpose computer, although those skilled in the art will appreciate that programmable or special purpose circuitry and equipment may be used. Communication control system 500 may be distributed among multiple devices that together comprise elements 520-560.

Communication interface 520 could comprise a network interface, modem, port, transceiver, or some other communication device. Communication interface 520 may be distributed among multiple communication devices. Processing system 530 could comprise a computer microprocessor, logic circuit, or some other processing device. Processing system 530 may be distributed among multiple processing devices. User interface 560 could comprise a keyboard, mouse, voice recognition interface, microphone and speakers, graphical display, touch screen, or some other type of user device. User interface 560 may be distributed among multiple user devices. Storage system 540 could comprise a disk, tape, integrated circuit, server, or some other memory device. Storage system 540 may be distributed among multiple memory devices.

Processing system 530 retrieves and executes software 550 from storage system 540. Software 550 may comprise an operating system, utilities, drivers, networking software, and other software typically loaded onto a computer system. Software 550 could comprise an application program, firmware, or some other form of machine-readable processing instructions. When executed by processing system 530, software 550 directs processing system 530 to operate as described herein.

Note that communication systems 100 and 300 provide a way to schedule packets in a wireless communication system that guarantees minimum bit rates while taking advantage of multi-user diversity. Communication systems 100 and 300 also provide a way to schedule packets in a wireless communication system that work for the case when packet flows are subject to idle and busy periods or if the channel state can assume multiple levels of varying efficiency.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a communication system to schedule packets, the method comprising:
receiving a first packet of a first plurality of packets to be sent to a first application running on a first wireless device, wherein the first packet is received over a first channel and wherein the first channel has a first channel condition history;
receiving a second packet of a second plurality of packets to be sent to a second application running on the first wireless device, wherein the second packet is received over a second channel and wherein the second channel has a second channel condition history;
determining if the first application has a first minimum rate guarantee, wherein if the first application has a first minimum rate guarantee, then assigning a first weight to the first packet based on the first minimum rate guarantee, and wherein if the first application does not have a first minimum rate guarantee, then not assigning a first weight to the first packet;
determining if the second application has a second minimum rate guarantee, wherein if the second application has a second minimum rate guarantee, then assigning a second weight to the second packet based on the second minimum rate guarantee, and wherein if the second application does not have a second minimum rate guarantee, then not assigning a second weight to the second packet;
determining a first channel performance indicator based on how the first channel is performing compared to the first channel condition history;
determining a second channel performance indicator based on how the second channel is performing compared to the second channel condition history; and
scheduling the first and second packets based on the first and second weights and on the first and second channel performance indicators.

2. The method of claim 1 wherein the second packet of the second plurality of packets is to be sent to the second application running on a second wireless device.

3. The method of claim 1 wherein if the first application has a first minimum rate guarantee then assigning a first arrival time, a first start tag, and a first finish tag to the first packet, wherein if the second application has a second minimum rate guarantee, then assigning a second arrival time, a second start tag, and a second finish tag to the second packet, and wherein the first application has a first virtual time and the second application has a second virtual time.

4. The method of claim 3 wherein scheduling the first and second packets further comprises scheduling the first packet before the second packet if the first start tag is at a time before the second start tag or scheduling the second packet before the first packet if the second start tag is at a time before the first start tag.

5. The method of claim 1 wherein the first channel performance indicator and the second channel performance indicator are based on a coding and modulation level.

6. The method of claim 2 wherein the first channel performance indicator and the second channel performance indicator are based on a coding and modulation level.

7. The method of claim 1 wherein scheduling the first and second packets further comprises scheduling the first packet before the second packet if the first channel performance indicator is greater than the second channel performance indicator or scheduling the second packet before the first packet if the second channel performance indicator is greater than the first channel performance indicator.

8. The method of claim 2 wherein scheduling the first and second packets further comprises scheduling the first packet before the second packet if the first channel performance indicator is greater than the second channel performance indicator or scheduling the second packet before the first packet if the second channel performance indicator is greater than the first channel performance indicator.

9. The method of claim 2 wherein if the first application has a first minimum rate guarantee, then assigning a first arrival time, a first start tag, and a first finish tag to the first packet, wherein if the second application has a second minimum rate guarantee, then assigning a second arrival time, a second start tag, and a second finish tag to the second packet, and wherein the first application has a first virtual time and the second application has a second virtual time.

10. The method of claim 9 wherein scheduling the first and second packets further comprises scheduling the first packet before the second packet if the first start tag is at a time before the second start tag or scheduling the second packet before the first packet if the second start tag is at a time before the first start tag.

11. A communication system for scheduling packets, the communication system comprising:
a base station;
a gateway, wherein the gateway communicates with the base station over a first communication link; and
a first wireless device, wherein the first wireless device communicates with the base station over a second communication link, wherein the second communication link has a first channel and a second channel, wherein the first channel has a first channel condition history, and wherein the second channel has a second channel condition history; and
wherein the gateway receives a first packet of a first plurality of packets to be sent to a first application running on the first wireless device; receives a second packet of a second plurality of packets to be sent to a second application running on the first wireless device; determines if the first application has a first minimum rate guarantee, wherein if the first application has a first minimum rate guarantee, then assigns a first weight to the first packet based on the first minimum rate guarantee, and wherein if the first application does not have a first minimum rate guarantee, then does not assign a first weight to the first packet; determines if the second application has a second minimum rate guarantee, wherein if the second application has a second minimum rate guarantee, then assigns a second weight to the second packet based on the second minimum rate guarantee, and wherein if the second application does not have a second minimum rate guarantee, then does not assign a second weight to the second packet; determines a first channel performance indicator based on how the first channel is performing compared to the first channel condition history; determines a second channel performance indicator based on how the second channel is performing compared to the second channel condition history; and schedules the first and second packets based on the first and second weights and on the first and second channel performance indicators.

12. The communication system of claim 11 further comprising a second wireless device, wherein the second wireless device communicates with the base station over a third communication link, wherein the third communication link has a third channel and a fourth channel, wherein the third channel has a third channel condition history, wherein the fourth channel has a fourth channel condition history, and wherein the gateway determines a third channel performance indicator based on how the third channel is performing compared to the third channel condition history; determines a fourth channel performance indicator based on how the fourth channel is performing compared to the fourth channel condition history; and schedules the first and second packets based on the first and second weights and on the third and fourth channel performance indicators.

13. The communication system of claim 11 wherein if the first application has a first minimum rate guarantee then the gateway assigns a first arrival time, a first start tag, and a first finish tag to the first packet, wherein if the second application has a second minimum rate guarantee, then the gateway assigns a second arrival time, a second start tag, and a second finish tag to the second packet, and wherein the first application has a first virtual time and the second application has a second virtual time.

14. The communication system of claim 13 wherein the gateway schedules the first packet before the second packet if the first start tag is at a time before the second start tag or schedules the second packet before the first packet if the second start tag is at a time before the first start tag.

15. The communication system of claim 11 wherein the first channel performance indicator and the second channel performance indicator are based on a coding and modulation level.

16. The communication system of claim 12 wherein the third channel performance indicator and the fourth channel performance indicator are based on a coding and modulation level.

17. The communication system of claim 11 wherein the gateway schedules the first packet before the second packet if the first channel performance indicator is greater than the second channel performance indicator or schedules the second packet before the first packet if the second channel performance indicator is greater than the first channel performance indicator.

18. The communication system of claim 12 wherein the gateway schedules the first packet before the second packet if the third channel performance indicator is greater than the fourth channel performance indicator or schedules the second packet before the first packet if the fourth channel performance indicator is greater than the third channel performance indicator.

19. The communication system of claim 12 wherein if the first application has a first minimum rate guarantee, then the gateway assigns a first arrival time, a first start tag, and a first finish tag to the first packet, wherein if the second application has a second minimum rate guarantee, then the gateway assigns a second arrival time, a second start tag, and a second finish tag to the second packet, and wherein the first application has a first virtual time and the second application has a second virtual time.

20. The communication system of claim 19 wherein the gateway schedules the first packet before the second packet if the first start tag is at a time before the second start tag or schedules the second packet before the first packet if the second start tag is at a time before the first start tag.
